(19) United States
(12) Patent Application Publication
(10) Pub. No.: US 2026/0359745 A1
(43) Pub. Date: Nov. 12, 2026

(54) SITUATIONAL-BASED EMPLOYEE SCHEDULING USING ARTIFICIAL INTELLIGENCE

(71) Applicant: IGT, Las Vegas, NV (US)

(72) Inventors: Eric Lancaster, Las Vegas, NV (US); Kevin Higgins, Reno, NV (US); Jacob Lanning, Las Vegas, NV (US); Dwayne Nelson, Las Vegas, NV (US); Jeffery Shepherd, Reno, NV (US); Ethan Edsall, Sparks, NV (US); Erik Petersen, Sparks, NV (US)

(21) Appl. No.: 19/200,199

(22) Filed: May 6, 2025

(51) Int. Cl. G06Q 10/0631; G07F 17/32

(52) U.S. Cl. CPC G06Q 10/063116; G07F 17/3237

(57) ABSTRACT

Embodiments of the present disclosure are directed to managing employees within a gaming venue. More specifically, employees, such as dealers, technicians, wait staffer, and/or others can be assigned, moved and monitored by a host system using Artificial Intelligence (AI). For example, the host system can maintain trained models related to the activity within the gaming venue. The models can include, but are not limited to, a player model defining characteristics of players and a personnel model defining characteristics of gaming venue personnel. The activity within the gaming venue can be monitored through sensors within the gaming venue and a change event related to the monitored activity can be detected. A recommendation for a personnel change can be generated based on the detected change event, the player model, and the personnel model and a notification of the recommendation can be provided, e.g., to the personnel and/or a supervisor or manager.

### BACKGROUND

The present disclosure is generally directed to monitoring and managing a gaming venue and more particularly to using artificial intelligence to manage employees within a gaming venue.

In a casino or gaming venue environment, matching the right dealer with the right player(s) improves the player experience and casino revenue. The dealer's appearance, style or communication, or lack of communication, may appeal to different players for different reasons.

Typically, dealers will rotate on a schedule of shifts and/or move between tables on a fixed schedule. A player could request a new dealer, and the casino supervisor or manager would have to make a judgement call on the switch, likely considering the value of the player.

Also, certain combinations of dealers and players can lead to cheating. This could be a dealer working with certain players, or players taking advantage of certain dealers. In any case, certain combinations of dealer player(s) cost the casino money in cheating or mistakes.

### BRIEF SUMMARY

Embodiments of the present disclosure are directed to using artificial intelligence to manage employees within a gaming venue. According to one embodiment, a method for managing activity within a gaming venue, can comprise maintaining a plurality of trained models related to the activity within the gaming venue. The plurality of trained models can comprise a player model defining characteristics of each of a plurality of players and a personnel model defining characteristics of each of a plurality of gaming venue personnel. The activity within the gaming venue can be monitored via a plurality of sensors disposed within the gaming venue and a change event related to the monitored activity within the gaming venue can be detected. a gaming venue personnel change recommendation can be generated based on the detected change event, the player model, and the personnel model and a notification of the generated gaming venue personnel change recommendation can be provided.

For example, the monitored activity can be related to personnel within the gaming venue and the detected change event can be based on time. Additionally, or alternatively, the monitored activity can be related to a player of a game within the gaming venue and the detected change event can be related to a change in play of the game by the player. The monitored activity can additionally, or alternatively, be related to a player of a game within the gaming venue and the detected change event can be a request from the player for a change of personnel within the gaming venue.

In some cases, the plurality of trained models can comprise a security model defining activities indicative of cheating in a game within the gaming venue. In such cases, monitoring the activity within the gaming venue can comprise monitoring activity of a dealer of the game and activity of a player of the game. Cheating within the game can be detected based on the monitored activity of the dealer of the game, the monitored activity of the player of the game, and the security model. A notification of the detected cheating within the game can be provided to security personnel of the gaming venue.

According to another embodiment, a system can comprise a processor and a memory coupled with and readable by the processor. The memory can store therein a set of instructions which, when executed by the processor, causes the processor to maintain a plurality of trained models related to the activity within the gaming venue. The plurality of trained models can comprise a player model defining characteristics of each of a plurality of players and a personnel model defining characteristics of each of a plurality of gaming venue personnel. The instructions can further cause the processor to monitor the activity within the gaming venue via a plurality of sensors disposed within the gaming venue, detect a change event related to the monitored activity within the gaming venue, generate a gaming venue personnel change recommendation based on the detected change event, the player model, and the personnel model, and provide a notification of the generated gaming venue personnel change recommendation.

For example, the monitored activity can be related to personnel within the gaming venue and the detected change event can be based on time. Additionally, or alternatively, the monitored activity can be related to a player of a game within the gaming venue and the detected change event can be related to a change in play of the game by the player. The monitored activity can additionally, or alternatively, be related to a player of a game within the gaming venue and the detected change event can be a request from the player for a change of personnel within the gaming venue.

In some cases, the plurality of trained models can comprise a security model defining activities indicative of cheating in a game within the gaming venue. In such cases, monitoring the activity within the gaming venue can comprise monitoring activity of a dealer of the game and activity of a player of the game. The instructions can further cause the processor to detect cheating within the game based on the monitored activity of the dealer of the game, the monitored activity of the player of the game, and the security model. The instructions can further cause the processor to provide a notification of the detected cheating within the game to security personnel of the gaming venue.

According to yet another embodiment, a system can comprise a communications network and a plurality of sensors coupled with the communications network. The plurality of sensors can monitor activity within a gaming venue. A gaming venue system can be coupled with the communications network. The gaming venue system can comprise a processor and a memory coupled with and readable by the processor and can store therein a set of instructions which, when executed by the processor, causes the processor to maintain a plurality of trained models related to the activity within the gaming venue. The plurality of trained models can comprise a player model defining characteristics of each of a plurality of players and a personnel model defining characteristics of each of a plurality of gaming venue personnel. The instructions can further cause the processor to monitor the activity within the gaming venue via a plurality of sensors disposed within the gaming venue, detect a change event related to the monitored activity within the gaming venue, generate a gaming venue personnel change recommendation based on the detected change event, the player model, and the personnel model, and provide a notification of the generated gaming venue personnel change recommendation.

For example, the monitored activity can be related to personnel within the gaming venue and the detected change event can be based on time. Additionally, or alternatively, the monitored activity can be related to a player of a game within the gaming venue and the detected change event can be related to a change in play of the game by the player. The monitored activity can additionally, or alternatively, be related to a player of a game within the gaming venue and the detected change event can be a request from the player for a change of personnel within the gaming venue.

In some cases, the plurality of trained models can comprise a security model defining activities indicative of cheating in a game within the gaming venue. In such cases, monitoring the activity within the gaming venue can comprise monitoring activity of a dealer of the game and activity of a player of the game. The instructions can further cause the processor to detect cheating within the game based on the monitored activity of the dealer of the game, the monitored activity of the player of the game, and the security model.

Additional features and advantages are described herein and will be apparent from the following Description and the figures.

### BRIEF DESCRIPTION OF THE SEVERAL VIEWS OF THE DRAWINGS

FIG. 1 illustrates an exemplary environment in which embodiments of the present disclosure may be implemented.

FIG. 2 illustrates another exemplary environment in which embodiments of the present disclosure may be implemented.

FIG. 3 is a block diagram illustrating additional details of components of an exemplary host system according to one embodiment of the present disclosure.

FIG. 4 is a flowchart illustrating an exemplary process for managing activity within a gaming venue according to one embodiment of the present disclosure.

FIG. 5 is a flowchart illustrating an exemplary process for managing activity within a gaming venue according to another embodiment of the present disclosure.

### DETAILED DESCRIPTION

Embodiments of the present disclosure are directed to managing personnel within a gaming venue. More specifically, employees, such as dealers, technicians, wait staff, and/or others can be assigned, moved and monitored by a host system using Artificial Intelligence (AI). For example, the host system can maintain trained models related to the activity within the gaming venue. The models can include, but are not limited to, a player model defining characteristics of players and a personnel model defining characteristics of gaming venue personnel. The activity within the gaming venue can be monitored through sensors within the gaming venue and a change event related to the monitored activity can be detected. A recommendation for a personnel change can be generated based on the detected change event, the player model, and the personnel model and a notification of the recommendation can be provided, e.g., to the personnel and/or a supervisor or manager.

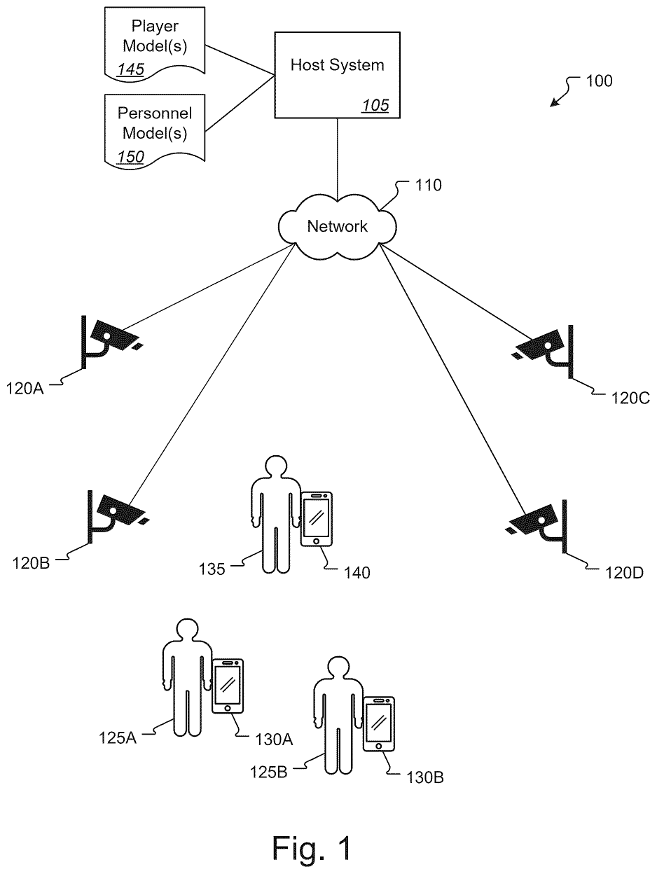

FIG. 1 illustrates an exemplary environment in which embodiments of the present disclosure may be implemented. As illustrated in this example, the environment 100 can include a gaming venue host system 105. The host system 105 can comprise any one or more servers and/or other computing devices. The host system 105 can be commutatively coupled with a network 110 such as a wired and/or wireless Local Area Network (LAN) within the gaming venue. Also coupled with the network 110 can be any number of sensors 120A-120D including, but not limited to, cameras, microphones, BlueTooth and/or other devices for detected cell phones and/or other mobile devices, etc.

Generally speaking, embodiments of the present disclosure are directed to managing personnel 125A-125B within a gaming venue. More specifically, employees, such as dealers, technicians, wait staffer, and/or others can be assigned, moved, etc. by the host system 105 using AI and trained models related to the activity within the gaming venue. The models can include, but are not limited to, a player model 145 defining characteristics of players and a personnel model 150 defining characteristics of gaming venue personnel. The activity of the personnel 125A-125B and players 135 within the gaming venue can be monitored through the sensors 120A-120D and a change event related to the monitored activity can be detected. A recommendation for a personnel change can be generated based on the detected change event, the player model 145, and the personnel model 150 and a notification of the recommendation can be provided, e.g., to the personnel 125A-125B and/or a supervisor or manager through a mobile device 130A-130B, radio, or other means.

More specifically, the host system 105 can use security cameras and other sensors 120A-120D to monitor gaming table activity. This can include monitoring the details of each hand and the outcome, how the players wagers, and which activities occurred, e.g., raise, stand, fold, etc. Additionally, the sensors 120A-120D can capture the movements of the player(s) and dealer.

Through this monitoring, the host system 105 can build models of the players which try to understand how they play and what makes them happy. At some point, a “Dealer Change” event can happen, and the right dealer can be assigned to the table based on the player model 145 for the player 135 or player behavior. The dealer change event could happen based on one or more of time, e.g., the dealer shift is over or it's time for the dealer to take a break, the host system 105 detecting that players are unhappy, disinterested or are wagering less, a player request, e.g., the players have requested a dealer change either by speaking with someone in the casino, using voice recognition, gesture recognition or using a mobile application executing on the player's 135 mobile device 140, at random, e.g., the host system 105 randomly changes while building a models, etc.

In one embodiment, the host system 105 can determine multiple people are necessary for the task. For example, the servicing of a gaming system such as an Electronic Gaming Machine (EGM) might require a hardware change and software change and two different people are necessary. In another example, multiple dealers may be necessary at a live table such as a craps table.

In one embodiment, the host system 105 can determine that a supervisor is necessary.

In one embodiment, the host system 105 can determine that a regulator is necessary. The host system 105 can understand, based on the models, that some regulations require the presence of a regulator, such as for changing software or software configuration of an EGM.

According to one embodiment, input to the host system 105 can be natural language and therefore the models might be a Large Language Model (LLM), for example. These AI models can take natural language input and provide output including natural language. For example, the host system 105 might query the LLM “Which employee is best to service EGM 1234?” and the LLM might respond with natural language (text or voice) result such as “Bob is the best because he was trained on the latest EGM cabinets”.

The input to an AI model can be natural language, text, documents, databases, pictures, sounds, etc. The output of the model can also be any of these forms. This versatility allows the host system 105 to handle diverse types of information and deliver results in various formats suitable for different applications.

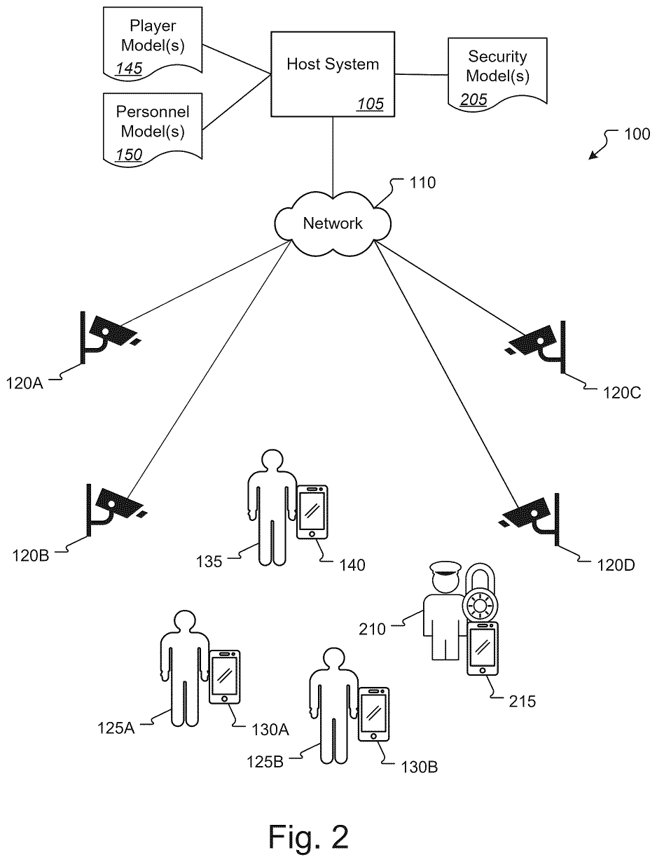

FIG. 2 illustrates another exemplary environment in which embodiments of the present disclosure may be implemented. As illustrated in this example, the host system can further train a security model 205. The security model 205 can define activities indicative of cheating in a game within the gaming venue. In such cases, monitoring the activity within the gaming venue by the host system 105 can comprise monitoring activity of a dealer 125A of the game and activity of a player 135 of the game. Using the security model 205, the host system can determine whether cheating within the game is detected based on the monitored activity of the dealer of the game and the monitored activity of the player of the game. In response to determining cheating is detected, the host system can provide a notification of the detected cheating to security personnel 210 of the gaming venue, e.g., through a mobile device 215, a radio, a display on a security system, etc.

Any of the models 145, 150, and 205 can be monitoring the events from EGMs and table system and monitoring which tickets (service jobs) each employee completes, how long, and the success. Additionally, the models 145, 150, and 205 can learn from its own activities. In this manner, there is a feedback loop for the models 145, 150, and 205 to become better and better over time.

Training can include the actual training of the models 145, 150, and 205, Retrieval Augmented Generation (RAG), or providing data to the context window of an already trained foundational model. For example, the system might provide a query to a one or many models and include natural language input in addition to a document that describes the regulations of the current game market or operating procedures for the casino. Alternatively, the input could involve a database of the user's gaming history, enabling the model to recommend an and assist players.

The host system's 105 integration with AI allows it to adapt and learn continuously. As more data is fed into the host system 105, it becomes increasingly better at predicting outcomes and suggesting wagers that align with the user's interests and regulatory requirements. This dynamic learning process enables the host system 105 10 remain relevant and accurate over time, offering a personalized and compliant wagering experience for each user.

The host system's 105 ability to process and analyze vast amounts of data quickly and accurately provides for a positive player experience. It can identify patterns and correlations that might not be immediately obvious to human operators. This can enhance the overall efficiency and effectiveness of the wagering system. By leveraging AI technologies, the host system 105 can provide innovative and reliable solutions in the realm of regulated wagering.

In the case of RAG, the models 145, 150, and 205 are not being trained but rather have access to some storage that can be queried to add to the model's knowledge for each request. In such cases, the models 145, 150, and 205 get the “data” from the storage as part of the request. This storage can be information about the player, the wagering history, wagering rules, ways to cheat, security events, etc. An example use of RAG according to one embodiment can be the host system 105 recording EGM events and personnel tickets in the storage. The models 145, 150, and 205 can then uses this information when the host system 105 queries/prompts the models 145, 150, and 205. The models 145, 150, and 205 can in turn query/prompt the storage and provide a response based on the data retrieved.

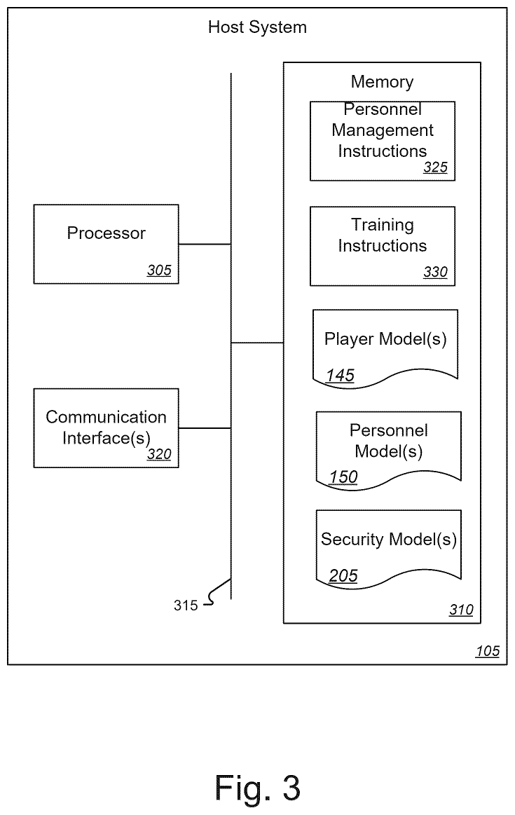

FIG. 3 is a block diagram illustrating additional details of components of an exemplary host system according to one embodiment of the present disclosure. As illustrated in this example, the surveillance system 105 can comprise a processor 305. The processor 305 may correspond to one or many computer processing devices. For instance, the processor 305 may be provided as silicon, as a Field Programmable Gate Array (FPGA), an Application-Specific Integrated Circuit (ASIC), any other type of Integrated Circuit (IC) chip, a collection of IC chips, or the like. As a more specific example, the processor 305 may be provided as a microprocessor, Central Processing Unit (CPU), or plurality of microprocessors that are configured to execute the instructions sets stored in a memory 310. Upon executing the instruction sets stored in memory 310, the processor 305 enables various functions of the host system 105 as described herein.

The memory 310 can be coupled with and readable by the processor 305 via a communications bus 315. The memory 310 may include any type of computer memory device or collection of computer memory devices. Non-limiting examples of memory 310 include Random Access Memory (RAM), Read Only Memory (ROM), flash memory, Electronically-Erasable Programmable ROM (EEPROM), Dynamic RAM (DRAM), etc. The memory 310 may be configured to store the instruction sets depicted in addition to temporarily storing data for the processor 305 to execute various types of routines or functions.

The processor 305 can also be coupled with one or more communication interfaces 320 via the communications bus 315. The communication interfaces 320 can comprise, for example, Ethernet, Bluetooth, WiFi, or other type of wired or wireless communications interfaces.

The memory 310 can store therein sets of instructions which, when executed by the processor 305, cause the processor 305 to operate the host system 105 as described herein. More specifically, the memory 310 can store therein a set of training instructions 330 which, when executed by the processor 305, can cause the processor 305 to train and maintain a plurality of models related to the activity within the gaming venue. The plurality of trained models can comprise a player model 145 defining characteristics of each of a plurality of players, a personnel model 150 defining characteristics of each of a plurality of gaming venue personnel, and a security model 205 defining activities indicative of cheating in a game within the gaming venue.

The memory 310 can further store therein a set of personnel management instructions 325 which, when executed by the processor 305, can cause the processor 305 to monitor activity within the gaming venue via the communications interface and a plurality of sensors 120A-120D disposed within the gaming venue and make a determination as to whether a change event has occurred. This determination can be made based on the monitoring of activity within the gaming venue, the models 145 and 150, a time of day, a personnel schedule, etc. For example, the monitored activity can be related to personnel within the gaming venue and the change event can be based on time. Additionally, or alternatively, the monitored activity can be related to a player of a game within the gaming venue and the change event can be related to a change in play of the game by the player. The monitored activity can additionally, or alternatively, be related to a player of a game within the gaming venue and the change event can be a request from the player for a change of personnel within the gaming venue.

In response to determining a change event has been detected, the personnel management instructions 325 can further cause the processor 305 to generate a gaming venue personnel change recommendation based on the detected change event, the player model 145, and the personnel model 150. For example, the recommendation can comprise an instruction to a dealer or other employee of the gaming venue to change locations, take a break, prepare for a shift change, etc. The personnel management instructions 325 can further cause the processor 305 to provide a notification of the generated gaming venue personnel change recommendation to the personnel, e.g., through the communications interface 320 and a mobile device 130, a radio, a display on a gaming table, etc.

Monitoring the activity within the gaming venue can comprise monitoring activity of a dealer of the game and activity of a player of the game. Accordingly, the personnel management instructions 325 can further cause the processor 305 to make a determination as to whether cheating within the game is detected based on the monitored activity of the dealer of the game, the monitored activity of the player of the game, and the security model 205. In response to determining cheating is detected, the personnel management instructions 325 can further cause the processor 305 to provide a notification of the detected cheating to security personnel of the gaming venue, e.g., through the communications interface 320 and a mobile device 215, a radio, a display on a security system, etc.

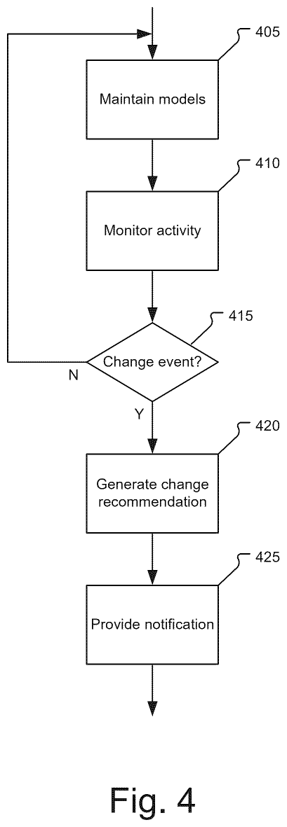

FIG. 4 is a flowchart illustrating an exemplary process for managing activity within a gaming venue according to one embodiment of the present disclosure. As illustrated in this example, managing activity within a gaming venue, can comprise maintaining 405 a plurality of trained models related to the activity within the gaming venue. The plurality of trained models can comprise a player model 145 defining characteristics of each of a plurality of players and a personnel model 150 defining characteristics of each of a plurality of gaming venue personnel. The activity within the gaming venue can be monitored 410 via a plurality of sensors 120A-120D disposed within the gaming venue.

A determination 415 can be made as to whether a change event has occurred. This determination 415 can be made based on the monitoring 410 of activity within the gaming venue, the models 145 and 150, a time of day, a personnel schedule, etc. For example, the monitored activity can be related to personnel within the gaming venue and the change event can be based on time. Additionally, or alternatively, the monitored activity can be related to a player of a game within the gaming venue and the change event can be related to a change in play of the game by the player. The monitored activity can additionally, or alternatively, be related to a player of a game within the gaming venue and the change event can be a request from the player for a change of personnel within the gaming venue.

In response to determining 415 a change event has been detected, a gaming venue personnel change recommendation can be generated 420 based on the detected change event, the player model 145, and the personnel model 150. For example, the recommendation can comprise an instruction to a dealer or other employee of the gaming venue to change locations, take a break, prepare for a shift change, etc. A notification of the generated 420 gaming venue personnel change recommendation can be provided 425 to the personnel, e.g., through a mobile device 130, a radio, a display on a gaming table, etc.

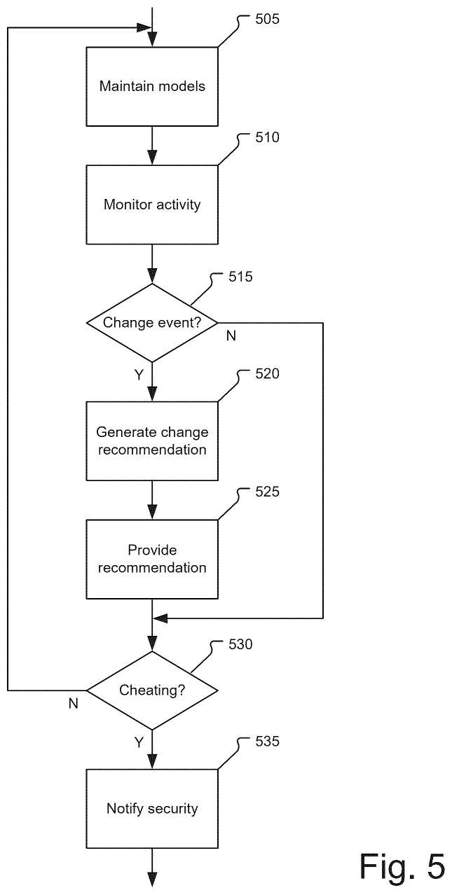

FIG. 5 is a flowchart illustrating an exemplary process for managing activity within a gaming venue according to another embodiment of the present disclosure. As illustrated in this example, managing activity within a gaming venue, can comprise maintaining 505 a plurality of trained models related to the activity within the gaming venue. The plurality of trained models can comprise a player model 145 defining characteristics of each of a plurality of players and a personnel model 150 defining characteristics of each of a plurality of gaming venue personnel. The activity within the gaming venue can be monitored 510 via a plurality of sensors 120A-120D disposed within the gaming venue.

A determination 515 can be made as to whether a change event has occurred. This determination 515 can be made based on the monitoring 510 of activity within the gaming venue, the models 145 and 150, a time of day, a personnel schedule, etc. For example, the monitored activity can be related to personnel within the gaming venue and the change event can be based on time. Additionally, or alternatively, the monitored activity can be related to a player of a game within the gaming venue and the change event can be related to a change in play of the game by the player. The monitored activity can additionally, or alternatively, be related to a player of a game within the gaming venue and the change event can be a request from the player for a change of personnel within the gaming venue.

In response to determining 515 a change event has been detected, a gaming venue personnel change recommendation can be generated 520 based on the detected change event, the player model 145, and the personnel model 150. For example, the recommendation can comprise an instruction to a dealer or other employee of the gaming venue to change locations, take a break, prepare for a shift change, etc. A notification of the generated 520 gaming venue personnel change recommendation can be provided 525 to the personnel, e.g., through a mobile device 130, a radio, a display on a gaming table, etc.

As noted above, the plurality of trained models can comprise a security model 205 defining activities indicative of cheating in a game within the gaming venue. In such cases, monitoring 510 the activity within the gaming venue can comprise monitoring activity of a dealer of the game and activity of a player of the game. Accordingly, a determination 530 can be made as to whether cheating within the game is detected based on the monitored activity of the dealer of the game, the monitored activity of the player of the game, and the security model 205. In response to determining 530 cheating is detected, a notification of the detected cheating can be provided 535 to security personnel of the gaming venue, e.g., through a mobile device 215, a radio, a display on a security system, etc.

A number of variations and modifications of the disclosure can be used. It would be possible to provide for some features of the disclosure without providing others.

The present disclosure contemplates a variety of different gaming systems each having one or more of a plurality of different features, attributes, or characteristics. A “gaming system” as used herein refers to various configurations of: (a) one or more central servers, central controllers, or remote hosts; (b) one or more electronic gaming machines such as those located on a casino floor; and/or (c) one or more personal gaming devices, such as desktop computers, laptop computers, tablet computers or computing devices, personal digital assistants, mobile phones, and other mobile computing devices. Moreover, an EGM as used herein refers to any suitable electronic gaming machine which enables a player to play a game (including but not limited to a game of chance, a game of skill, and/or a game of partial skill) to potentially win one or more awards, wherein the EGM comprises, but is not limited to: a slot machine, a video poker machine, a video lottery terminal, a terminal associated with an electronic table game, a video keno machine, a video bingo machine located on a casino floor, a sports betting terminal, or a kiosk, such as a sports betting kiosk.

In various embodiments, the gaming system of the present disclosure includes: (a) one or more electronic gaming machines in combination with one or more central servers, central controllers, or remote hosts; (b) one or more personal gaming devices in combination with one or more central servers, central controllers, or remote hosts; (c) one or more personal gaming devices in combination with one or more electronic gaming machines; (d) one or more personal gaming devices, one or more electronic gaming machines, and one or more central servers, central controllers, or remote hosts in combination with one another; (e) a single electronic gaming machine; (f) a plurality of electronic gaming machines in combination with one another; (g) a single personal gaming device; (h) a plurality of personal gaming devices in combination with one another; (i) a single central server, central controller, or remote host; and/or (j) a plurality of central servers, central controllers, or remote hosts in combination with one another.

For brevity and clarity and unless specifically stated otherwise, “EGM” as used herein represents one EGM or a plurality of EGMs, “personal gaming device” as used herein represents one personal gaming device or a plurality of personal gaming devices, and “central server, central controller, or remote host” as used herein represents one central server, central controller, or remote host or a plurality of central servers, central controllers, or remote hosts.

As noted above, in various embodiments, the gaming system includes an EGM (or personal gaming device) in combination with a central server, central controller, or remote host. In such embodiments, the EGM (or personal gaming device) is configured to communicate with the central server, central controller, or remote host through a data network or remote communication link. In certain such embodiments, the EGM (or personal gaming device) is configured to communicate with another EGM (or personal gaming device) through the same data network or remote communication link or through a different data network or remote communication link. For example, the gaming system includes a plurality of EGMs that are each configured to communicate with a central server, central controller, or remote host through a data network.

In certain embodiments in which the gaming system includes an EGM (or personal gaming device) in combination with a central server, central controller, or remote host, the central server, central controller, or remote host is any suitable computing device (such as a server) that includes at least one processor and at least one memory device or data storage device. As further described herein, the EGM (or personal gaming device) includes at least one EGM (or personal gaming device) processor configured to transmit and receive data or signals representing events, messages, commands, or any other suitable information between the EGM (or personal gaming device) and the central server, central controller, or remote host. The at least one processor of that EGM (or personal gaming device) is configured to execute the events, messages, or commands represented by such data or signals in conjunction with the operation of the EGM (or personal gaming device). Moreover, the at least one processor of the central server, central controller, or remote host is configured to transmit and receive data or signals representing events, messages, commands, or any other suitable information between the central server, central controller, or remote host and the EGM (or personal gaming device). The at least one processor of the central server, central controller, or remote host is configured to execute the events, messages, or commands represented by such data or signals in conjunction with the operation of the central server, central controller, or remote host. One, more than one, or each of the functions of the central server, central controller, or remote host may be performed by the at least one processor of the EGM (or personal gaming device). Further, one, more than one, or each of the functions of the at least one processor of the EGM (or personal gaming device) may be performed by the at least one processor of the central server, central controller, or remote host.

In certain such embodiments, computerized instructions for controlling any games (such as any primary or base games and/or any secondary or bonus games) displayed by the EGM (or personal gaming device) are executed by the central server, central controller, or remote host. In such “thin client” embodiments, the central server, central controller, or remote host remotely controls any games (or other suitable interfaces) displayed by the EGM (or personal gaming device), and the EGM (or personal gaming device) is utilized to display such games (or suitable interfaces) and to receive one or more inputs or commands. In other such embodiments, computerized instructions for controlling any games displayed by the EGM (or personal gaming device) are communicated from the central server, central controller, or remote host to the EGM (or personal gaming device) and are stored in at least one memory device of the EGM (or personal gaming device). In such “thick client” embodiments, the at least one processor of the EGM (or personal gaming device) executes the computerized instructions to control any games (or other suitable interfaces) displayed by the EGM (or personal gaming device).

In various embodiments in which the gaming system includes a plurality of EGMs (or personal gaming devices), one or more of the EGMs (or personal gaming devices) are thin client EGMs (or personal gaming devices) and one or more of the EGMs (or personal gaming devices) are thick client EGMs (or personal gaming devices). In other embodiments in which the gaming system includes one or more EGMs (or personal gaming devices), certain functions of one or more of the EGMs (or personal gaming devices) are implemented in a thin client environment, and certain other functions of one or more of the EGMs (or personal gaming devices) are implemented in a thick client environment. In one such embodiment in which the gaming system includes an EGM (or personal gaming device) and a central server, central controller, or remote host, computerized instructions for controlling any primary or base games displayed by the EGM (or personal gaming device) are communicated from the central server, central controller, or remote host to the EGM (or personal gaming device) in a thick client configuration, and computerized instructions for controlling any secondary or bonus games or other functions displayed by the EGM (or personal gaming device) are executed by the central server, central controller, or remote host in a thin client configuration.

In certain embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a local area network (LAN) in which the EGMs (or personal gaming devices) are located substantially proximate to one another and/or the central server, central controller, or remote host. In one example, the EGMs (or personal gaming devices) and the central server, central controller, or remote host are located in a gaming establishment or a portion of a gaming establishment.

In other embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a wide area network (WAN) in which one or more of the EGMs (or personal gaming devices) are not necessarily located substantially proximate to another one of the EGMs (or personal gaming devices) and/or the central server, central controller, or remote host. For example, one or more of the EGMs (or personal gaming devices) are located: (a) in an area of a gaming establishment different from an area of the gaming establishment in which the central server, central controller, or remote host is located; or (b) in a gaming establishment different from the gaming establishment in which the central server, central controller, or remote host is located. In another example, the central server, central controller, or remote host is not located within a gaming establishment in which the EGMs (or personal gaming devices) are located. In certain embodiments in which the communication network includes a WAN, the gaming system includes a central server, central controller, or remote host and an EGM (or personal gaming device) each located in a different gaming establishment in a same geographic area, such as a same city or a same state. Gaming systems in which the communication network includes a WAN are substantially identical to gaming systems in which the communication network includes a LAN, though the quantity of EGMs (or personal gaming devices) in such gaming systems may vary relative to one another.

In further embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include an internet (such as the Internet) or an intranet. In certain such embodiments, an Internet browser of the EGM (or personal gaming device) is usable to access an Internet game page from any location where an Internet connection is available. In one such embodiment, after the EGM (or personal gaming device) accesses the Internet game page, the central server, central controller, or remote host identifies a player before enabling that player to place any wagers on any plays of any wagering games. In one example, the central server, central controller, or remote host identifies the player by requiring a player account of the player to be logged into via an input of a unique player name and password combination assigned to the player. The central server, central controller, or remote host may, however, identify the player in any other suitable manner, such as by validating a player tracking identification number associated with the player; by reading a player tracking card or other smart card inserted into a card reader; by validating a unique player identification number associated with the player by the central server, central controller, or remote host; or by identifying the EGM (or personal gaming device), such as by identifying the MAC address or the IP address of the Internet facilitator. In various embodiments, once the central server, central controller, or remote host identifies the player, the central server, central controller, or remote host enables placement of one or more wagers on one or more plays of one or more primary or base games and/or one or more secondary or bonus games, and displays those plays via the Internet browser of the EGM (or personal gaming device). Examples of implementations of Internet-based gaming are further described in U.S. Pat. No. 8,764,566, entitled “Internet Remote Game Server,” and U.S. Pat. No. 8,147,334, entitled “Universal Game Server.”

The central server, central controller, or remote host and the EGM (or personal gaming device) are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile Internet network), or any other suitable medium. The expansion in the quantity of computing devices and the quantity and speed of Internet connections in recent years increases opportunities for players to use a variety of EGMs (or personal gaming devices) to play games from an ever-increasing quantity of remote sites. Additionally, the enhanced bandwidth of digital wireless communications may render such technology suitable for some or all communications, particularly if such communications are encrypted. Higher data transmission speeds may be useful for enhancing the sophistication and response of the display and interaction with players.

As should be appreciated by one skilled in the art, aspects of the present disclosure have been illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C #, VB. NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure have been described herein with reference to flowchart illustrations and/or block diagrams of methods, apparatuses (systems) and computer program products according to embodiments of the disclosure. It should be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

What is claimed is:

1. A method for managing activity within a gaming venue, the method comprising:
maintaining, by a gaming venue management system, a plurality of trained models related to the activity within the gaming venue, the plurality of trained models comprising a player model defining characteristics of each of a plurality of players and a personnel model defining characteristics of each of a plurality of gaming venue personnel;
monitoring, by the gaming venue management system, the activity within the gaming venue via a plurality of sensors disposed within the gaming venue;
detecting, by the gaming venue management system, a change event related to the monitored activity within the gaming venue;
generating, by the gaming venue management system, a gaming venue personnel change recommendation based on the detected change event, the player model, and the personnel model; and
providing, by the gaming venue management system, a notification of the generated gaming venue personnel change recommendation.

2. The method of claim 1, wherein the monitored activity is related to personnel within the gaming venue and wherein the detected change event is based on time.

3. The method of claim 1, wherein the monitored activity is related to a player of a game within the gaming venue and wherein the detected change event is related to a change in play of the game by the player.

4. The method of claim 1, wherein the monitored activity is related to a player of a game within the gaming venue and wherein the detected change event is a request from the player for a change of personnel within the gaming venue.

5. The method of claim 1, wherein the plurality of trained models comprises a security model defining activities indicative of cheating in a game within the gaming venue.

6. The method of claim 5, wherein monitoring the activity within the gaming venue comprises monitoring activity of a dealer of the game and activity of a player of the game and wherein the method further comprises detecting cheating within the game based on the monitored activity of the dealer of the game, the monitored activity of the player of the game, and the security model.

7. The method of claim 6, further comprising providing a notification of the detected cheating within the game to security personnel of the gaming venue.

8. A system comprising:
a processor; and
a memory coupled with and readable by the processor and storing therein a set of instructions which, when executed by the processor, causes the processor to:
maintain a plurality of trained models related to an activity within a gaming venue, the plurality of trained models comprising a player model defining characteristics of each of a plurality of players and a personnel model defining characteristics of each of a plurality of gaming venue personnel;
monitor the activity within the gaming venue via a plurality of sensors disposed within the gaming venue;
detect a change event related to the monitored activity within the gaming venue;
generate a gaming venue personnel change recommendation based on the detected change event, the player model, and the personnel model; and
provide a notification of the generated gaming venue personnel change recommendation.

9. The system of claim 8, wherein the monitored activity is related to personnel within the gaming venue and wherein the detected change event is based on time.

10. The system of claim 8, wherein the monitored activity is related to a player of a game within the gaming venue and wherein the detected change event is related to a change in play of the game by the player.

11. The system of claim 8, wherein the monitored activity is related to a player of a game within the gaming venue and wherein the detected change event is a request from the player for a change of personnel within the gaming venue.

12. The system of claim 8, wherein the plurality of trained models comprises a security model defining activities indicative of cheating in a game within the gaming venue.

13. The system of claim 12, wherein monitoring the activity within the gaming venue comprises monitoring activity of a dealer of the game and activity of a player of the game and wherein the instructions further cause the processor to detect cheating within the game based on the monitored activity of the dealer of the game, the monitored activity of the player of the game, and the security model.

14. The system of claim 13, wherein the instructions further cause the processor to provide a notification of the detected cheating within the game to security personnel of the gaming venue.

15. A system comprising:
a communications network;
a plurality of sensors coupled with the communications network, the plurality of sensors monitoring activity within a gaming venue; and
a gaming venue system coupled with the communications network, the gaming venue system comprising a processor and a memory coupled with and readable by the processor and storing therein a set of instructions which, when executed by the processor, causes the processor to:
maintain a plurality of trained models related to an activity within the gaming venue, the plurality of trained models comprising a player model defining characteristics of each of a plurality of players and a personnel model defining characteristics of each of a plurality of gaming venue personnel;
monitor the activity within the gaming venue via a plurality of sensors disposed within the gaming venue;
detect a change event related to the monitored activity within the gaming venue;
generate a gaming venue personnel change recommendation based on the detected change event, the player model, and the personnel model; and
provide a notification of the generated gaming venue personnel change recommendation.

16. The system of claim 15, wherein the monitored activity is related to personnel within the gaming venue and wherein the detected change event is based on time.

17. The system of claim 15, wherein the monitored activity is related to a player of a game within the gaming venue and wherein the detected change event is related to a change in play of the game by the player.

18. The system of claim 15, wherein the monitored activity is related to a player of a game within the gaming venue and wherein the detected change event is a request from the player for a change of personnel within the gaming venue.

19. The system of claim 15, wherein the plurality of trained models comprises a security model defining activities indicative of cheating in a game within the gaming venue.

20. The system of claim 19, wherein monitoring the activity within the gaming venue comprises monitoring activity of a dealer of the game and activity of a player of the game and wherein the instructions further cause the processor to detect cheating within the game based on the monitored activity of the dealer of the game, the monitored activity of the player of the game, and the security model.
